(19) United States
(12) Patent Application Publication
(10) Pub. No.: US 2016/0044420 A1
(43) Pub. Date: Feb. 11, 2016

(54) Receiver With Common Coil Core Structure

(71) Applicant: Knowles Electronics, LLC, Itasca, IL (US)

(72) Inventors: Shehab Albahri, Hanover Park, IL (US); Chris Jones, Carpentersville, IL (US); Todd Zhang, Jiangsu (CN)

(21) Appl. No.: 14/818,787

(22) Filed: Aug. 5, 2015

Related U.S. Application Data
(60) Provisional application No. 62/033,858, filed on Aug. 6, 2014.

(51) Int. Cl. H04R 11/02

(52) U.S. Cl. CPC H04R 11/02

(57) ABSTRACT

A dual receiver includes a housing; a first armature, a second armature, a single coil, at least one magnet, a first diaphragm, a second diaphragm. The first armature is disposed in the housing and includes a first moving portion and a first non-moving portion. The second armature is disposed in the housing and includes a second moving portion and a second non-moving portion. The single coil extends around the first non-moving portion of the first armature and the second non-moving portion of the second armature. The at least one magnet is disposed about the housing. A first diaphragm is coupled to the first armature and a second diaphragm coupled to the second armature. Current excites the coil and responsively with the at least one magnet creates a magnetic flux that moves the first diaphragm to create a first sound and moves the second diaphragm to create a second sound.

### CROSS REFERENCE TO RELATED APPLICATION

This patent claims benefit under 35 U.S.C. §119 (e) to U.S. Provisional Application No. 62/033,858 entitled “Receiver with common coil structure” filed Aug. 6, 2014, the content of which is incorporated herein by reference in its entirety.

### TECHNICAL FIELD

This application relates to receivers and the configuration of internal components of these receivers.

### BACKGROUND OF THE INVENTION

Receivers are used in many of today's electronic devices. A receiver converts electrical signals representing voice into acoustic energy that is presented for listening to a user. For example, receivers can be used in hearing instruments, personal computers, cellular phones to mention a few examples.

The receiver typically includes several components. For example, these devices usually include a coil, a stack, magnets, and a reed (or armature). The reed is connected to a diaphragm. Electrical current (representing sound) excites the coil, creating a magnetic field/flux together with the magnets, and this moves the reed. Since the reed is connected with the diaphragm, as the reed moves the diaphragm and displaces air, thereby creating sound.

Dual receivers have also been developed. In a dual receiver system two receivers are used together to produce sound.

However, there have been some problems with these previous approaches. Using the previous approaches, many different components were needed and this resulted in a high part count for these systems. For example, each of the receivers required a separate coil as well as other separate components. These problems have resulted in some user dissatisfaction with previous approaches.

### BRIEF DESCRIPTION OF THE DRAWINGS

For a more complete understanding of the disclosure, reference should be made to the following detailed description and accompanying drawings wherein:

FIG. 1 comprises a perspective view of a receiver module according to various embodiments of the present invention;

FIG. 2 comprises a side view of the receiver of FIG. 1 taken along line A-A according to various embodiments of the present invention;

FIG. 3 comprises a perspective view of an armature according to various embodiments of the present invention;

FIG. 4 comprises a perspective view of an armature and coil according to various embodiments of the present invention;

FIG. 5 comprises a perspective, cross-sectional side view of a receiver according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches can be used in dual receiver devices. The present approaches use a common coil core that helps to move two reeds in two receiver structures. The use of the common coil portion reduces the amount of parts needed to construct the dual receiver. Consequently, the cost of producing the receiver is reduced resulting in greater user satisfaction with these approaches.

In many of these embodiments, a dual receiver includes a housing; a first armature, a second armature, a single coil, at least one magnet, a first diaphragm, a second diaphragm. The first armature is disposed in the housing and includes a first moving portion and a first non-moving portion. The second armature is disposed in the housing and includes a second moving portion and a second non-moving portion. The single coil extends around the first non-moving portion of the first armature and the second non-moving portion of the second armature. The at least one magnet is disposed about the housing. A first diaphragm is coupled to the first armature and a second diaphragm coupled to the second armature. Current excites the coil and responsively with the at least one magnet creates a magnetic flux that moves the first diaphragm to create a first sound and moves the second diaphragm to create a second sound.

In some examples, the first sound and the second sound are combined in a sound tube for presentation to a listener.

In other aspects, the first armature and the second armature are generally u-shaped.

In some examples, the housing is constructed of a first portion and a second portion. In some aspects, the first portion is constructed of a material with sufficient magnetic saturation. In some examples, the second portion is constructed of a material with sufficient magnetic permeability.

In other examples, the first armature and the second armature are separate elements. In some aspects, the first armature and the second armature a single element. In other aspects, the at least one magnet is supported by one or more of the first armature and the second armature.

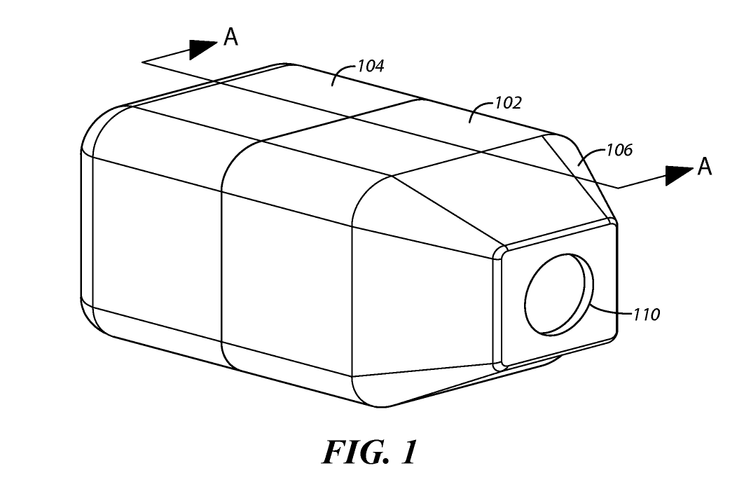

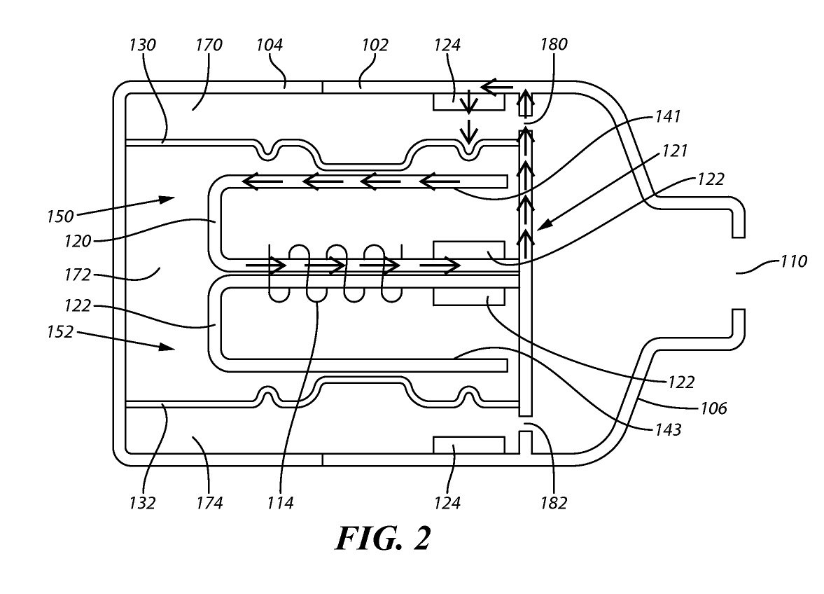

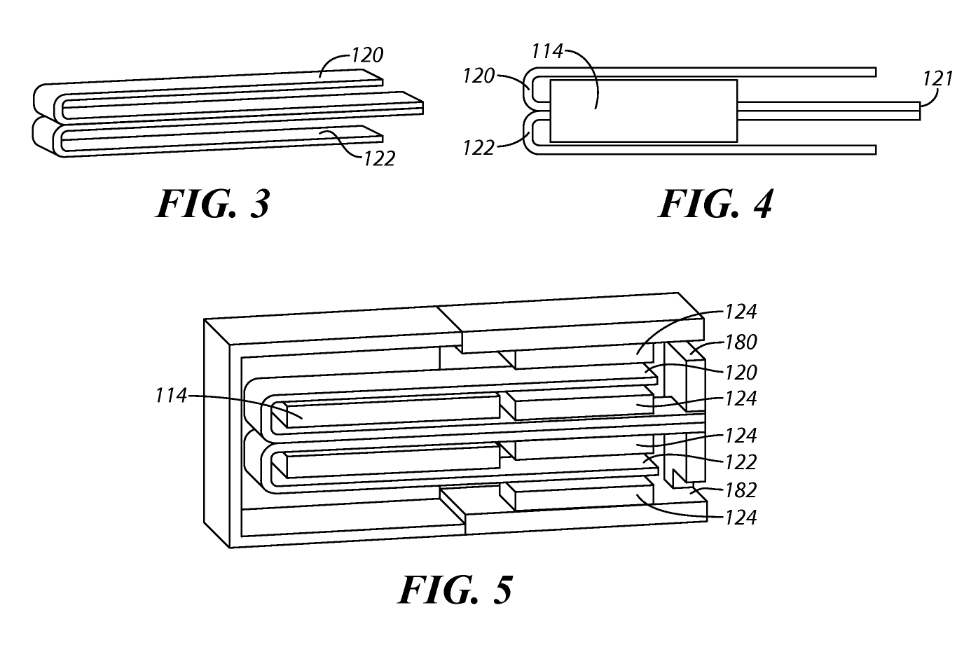

Referring now to FIGS. 1-5, one example of a dual receiver 100 is described. The dual receiver includes a first receiver 150 and a second receiver 152. The receivers 150, 152 are integrated and coupled together in a common housing arrangement.

The housing arrangement includes a first portion 102 and a second portion 104. The first portion 102 and the second portion 104 may be constructed of the same material. In another example, the first portion 102 and the second portion 104 may be constructed of different materials. The use of different materials is advantageous since it could be optimized to increasing magnetic shielding. In one example of using different materials, the first portion 102 is constructed of high magnetic saturation alloy such commercially available Carpenter 49 alloy. The second portion 104 is constructed of high magnetic permeability alloy such as commercially available Carpenter HyMu 80 alloy. Other examples of materials are possible.

A sound tube 106 has an opening 110 and is coupled to the first portion 102. Sound produced by the receivers 150, 152 traverses the sound tube 106 and exits at the opening 110 and may be presented to a listener.

A first armature 120 is connected to a second armature 122. In one aspect, the armatures 120, 122 are generally u-shaped and can be connected by any suitable attachment mechanism such as gluing or welding. Other connection or attachment approaches may also be used. It will also be appreciated that the first armature 120 and the second armature 122 may be combined, integrated, or formed into a single-piece armature that, for example, may be formed by injection molding techniques.

A common coil area or portion includes a common coil 114 and the portions of the armatures 120, 122 that are coupled together. Magnets 122 are attached to the first armature 120 and the second armature 122. Magnets 124 are also coupled to the housing.

A first diaphragm 130 is coupled to the first armature 120. A second diaphragm 132 is coupled to the second armature 122. The various elements may be coupled together by gluing or by any other appropriate attachment mechanism or arrangement. The coil 114 wraps around the stationary part of the armatures.

The armatures 120, 122 may be constructed of an iron/nickel compound (in one example, the material is approximately 50% of each of these materials). As mentioned, the armatures 120, 122 are u-shaped and have moving portions 141 and 143, respectively.

A first front volume 170 and a common back volume 172 are formed and are separated by the first diaphragm 130. A second front volume 174 is formed and separated from the common back volume 172 by the second diaphragm 132.

It will be appreciated that the use of the common core portion 121 (that includes the coil 114 (that is shared between the two receivers 150 and 152) and the armature portion that supports the magnets 122) reduces the number of parts required in the receiver 100. For example and according to these approaches, only one coil is needed, not two coils. Additionally, only one support structure for the magnets is needed, not two separate and disconnected support structures.

Electrical current excites the coil 114 and creates a magnetic flux path or magnetic circuit 117. The moving portion 141 of the first armature 120 moves and the moving portion 143 of the second armature 122 also moves.

Consequently, when the moving portion 141 of the first armature 120 moves, the first diaphragm 130 moves (because the first diaphragm 130 and the armature 120 are directly coupled together). When the moving portion 143 of the second armature 122 moves, the second diaphragm 132 moves (because the second diaphragm 132 and the armature 122 are directly coupled together).

When the first diaphragm 130 moves, sound is created in the first front volume 170 and this sound exits the first front volume 170 through an opening 180. When the second diaphragm 132 moves, sound is created in the second front volume 174 and this sound exits the second front volume through an opening 182. Whether exiting through opening 180 or opening 182, the sound traverses the sound tube 106 to exit the receiver at the opening 110 for presentation to a listener.

Consequently, the present approaches provide a common coil core in a common coil core portion and the coil is configured to, when actuated, create magnetic flux lines that move two reeds in two receiver structures. The use of the common coil portion reduces the amount of parts needed to construct the dual receiver since, for example, only a single coil is used rather than two coils. Consequently, the cost of producing the receiver is reduced resulting in greater user satisfaction with these approaches.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A dual receiver comprising:
a housing;
a first armature disposed in the housing, the first armature including a first moving portion and a first non-moving portion;
a second armature disposed in the housing, the second armature including a second moving portion and a second non-moving portion;
a single coil extending around the first non-moving portion of the first armature and the second non-moving portion of the second armature;
at least one magnet disposed about the housing;
a first diaphragm coupled to the first armature;
a second diaphragm coupled to the second armature;
such that current excites the coil and responsively with the at least one magnet creates a magnetic flux that moves the first diaphragm to create a first sound and moves the second diaphragm to create a second sound.

2. The dual receiver of claim 1, wherein the first sound and the second sound are combined in a sound tube for presentation to a listener.

3. The dual receiver of claim 1, wherein the first armature and the second armature are generally u-shaped.

4. The dual receiver of claim 1, wherein the housing is constructed of a first portion and a second portion.

5. The dual receiver of claim 4, wherein the first portion is constructed of a material with sufficient magnetic saturation.

6. The dual receiver of claim 4, wherein the second portion is constructed of a material with sufficient magnetic permeability.

7. The dual receiver of claim 1, wherein the first armature and the second armature are separate elements.

8. The dual receiver of claim 1, wherein the first armature and the second armature a single element.

9. The dual receiver of claim 1, wherein the at least one magnet is supported by one or more of the first armature and the second armature.
